(19) United States
(12) Patent Application Publication
(10) Pub. No.: US 2026/0319664 A1
(43) Pub. Date: Oct. 15, 2026

(54) MEMORY SYSTEM SUPPORTING MULTI-CIRCULAR QUEUE (MCQ) FUNCTIONALITY WITH REDUCED LATENCY

(71) Applicant: QUALCOMM Incorporated, San Diego, CA (US)

(72) Inventors: Asutosh Das, San Diego, CA (US); Can Guo, Shanghai (CN); Chandan Pramod Attarde, Bangalore (IN); Goutham Kumar Karnati, Choutuppal (IN)

(21) Appl. No.: 19/482,604

(22) PCT Filed: Jun. 16, 2023
(86) PCT No.: PCT/CN2023/100701

§ 371 Date: Nov. 7, 2025

(51) Int. Cl. G06F 3/06

(52) U.S. Cl. CPC G06F 3/0611; G06F 3/0659; G06F 3/0679

(57) ABSTRACT

Systems, methods, and devices for memory systems that support reduced latency multi-circular queue (MCQ) functionality. In a first aspect, a method performed by a host memory controller in a flash memory system includes storing response information as an entry in a completion queue based on a response received from a memory system coupled to a host device. The method includes updating an entry in a completion queue pointer register corresponding to the completion queue based on storage of the response information at the completion queue. The method includes clearing an entry in a completion queue interrupt status (CQIS) register, and, after clearing the entry in the CQIS register, issuing a MCQ event specific interrupt (ESI) to a processor core of the host device.

### TECHNICAL FIELD

Aspects of the present disclosure relate generally to an apparatus and method for controlling a memory device. Some aspects may, more particularly, relate to an apparatus and method for controlling operations of a host device to support multi-circular queue (MCQ) functionality with reduced latency.

### INTRODUCTION

As the value and use of information continues to increase, individuals and businesses seek additional ways to process and store information. In addition, the use of information in various locations and desired portability of information is increasing. For this reason, users are increasingly turning towards the use of portable electronic devices, such as mobile phones, digital cameras, laptop computers and the like. Portable electronic devices generally employ a memory system using a memory device for storing data. A memory system may be used as a main memory or an auxiliary memory of a portable electronic device.

The memory device of the memory system may include one kind or a combination of kinds of storage. For example, magnetic-based memory systems, such as hard disk drives (HDDs), store data by encoding data as a combination of small magnets. As another example, optical-based memory systems, such as digital versatile discs (DVDs) and Blu-ray media, store data by encoding data as physical bits that cause different reflections when illuminated by a light source. As a further example, electronic memory devices store data as collections of electrons that can be detected through voltage and/or current measurements.

Electronic memory devices can be advantageous in certain systems in that they may access data quickly and consume a small amount of power. Examples of an electronic memory device having these advantages include universal serial bus (USB) memory devices (sometimes referred to as “memory sticks”), a memory card (such as used in some cameras and gaming systems), and solid state drive (SSDs) (such as used in laptop computers). NAND flash memory is one kind of memory device that may be used in electronic memory devices. NAND flash memory is manufactured into memory cards or flash disks. Example memory cards include compact flash (CF) cards, multimedia cards (eMMCs), smart media (SM) cards, and secure digital (SD) cards.

A memory system may, in some cases, be integrated with or otherwise connected to a host device, such as an electronic device. For example, memory systems may be integrated with host devices in a system on chip (SoC). As one particular example, a flash memory system, which may be a universal flash storage (UFS) memory system, may be integrated into an electronic device, such as an access point (AP), station (STA), user equipment (UE), base station, modem, camera, automobile, or other system.

Flash memory systems, such as a UFS memory system, provide improved storage capabilities with fast access times, resulting in the proliferation of flash memories in a variety of devices. As host device complexity increases, flash memories are being designed to leverage new features of host devices. For example, host devices may include multiple central processing unit (CPU) cores, which may cause challenges when more than one CPU core attempts to transfer data to or from a flash memory device. For example, a host controller may maintain queues in host memory (e.g., in memory-mapped input/output (MMIO)) for storing data and instructions for transmitting to a flash memory device. However, such queues may be assigned to a particular CPU core or may only be accessed by one CPU core at a time, causing delay for at least one CPU core when multiple CPU cores attempt to access the same queue. Additionally, because the queues may trigger interrupts when accessed by a CPU core or by the host controller, interrupt handling that accesses the host controller memory (e.g., the queues) can add latency that reduces throughput to the flash memory device.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Aspects disclosed herein describe host systems and memory systems, such as flash memory devices, that support multi-circular queue (MCQ) functionality, such as a plurality of queues implemented in memory of a host controller (e.g., a host memory controller) that may be accessed by multiple processor cores of the host device. Aspects described herein also enable event-specific interrupt handling with reduced latency by reducing a number of interrupt handler accesses to memory-mapped input/output (MMIO) at the host controller. For example, a host controller may be configured to operate according to a universal flash storage (UFS) standard, which may include supporting a MCQ event specific interrupt (ESI) that is issued when a completion queue pointer register is updated by the host controller to report completion of an operation at a flash memory device. Because the MCQ ESI indicates which completion queue from a plurality of completion queues caused the interrupt to issue, a MCQ ESI handler executed at a processor core that receives the MCQ ESI may determine which completion queue to access based on the MCQ ESI, instead of by reading identifying information from a completion queue interrupt status (CQIS) register. Because the CQIS status register is not needed to provide the identifying information to the MCQ ESI handler, the host controller may clear the CQIS register prior to issuing the MCQ ESI to the processor core. Because the host controller can access the CQIS register without performing memory mapping to generate a MMIO address, the CQIS register is cleared faster than if the MCQ ESI handler were to handle the clearing, thereby reducing latency of each operation that accesses the flash memory device.

In one aspect of the disclosure, an apparatus includes a memory controller of a host device configured to couple the host device to a memory system through a first interface. The memory controller is configured to perform operations including storing, by the memory controller, response information as an entry in a completion queue based on a response received from the memory system. The operations also include updating, by the memory controller, an entry in a completion queue (CQ) pointer register corresponding to the completion queue based on storage of the response information at the completion queue. The operations include clearing, by the memory controller, an entry in a CQIS register. The operations further include, after clearing the entry in the CQIS register, issuing, by the memory controller, a MCQ ESI to a processor core of the host device.

In another aspect of the disclosure, a method for performing these operations by a processor by executing instructions stored in a memory coupled to the processor is also disclosed. For example, the method includes storing, by a memory controller of a host device, response information as an entry in a completion queue based on a response received from a memory system coupled to the host device through a first interface. The method also includes updating, by the memory controller, an entry in a CQ pointer register corresponding to the completion queue based on storage of the response information at the completion queue. The method includes clearing, by the memory controller, an entry in a CQIS register. The method further includes, after clearing the entry in the CQIS register, issuing, by the memory controller, a MCQ ESI to a processor core of the host device. In an additional aspect of the disclosure, a non-transitory computer-readable medium stores instructions that, when executed by a processor, cause the processor to perform these operations.

In another aspect of the disclosure, a wireless communication device includes a multi-core processor, a flash memory device, and a memory controller coupled to the multi-core processor and the flash memory device. The multi-core processor includes a first processor core and a second processor core. The memory controller is coupled to the flash memory device through a first interface and configured to perform operations including storing, by the memory controller, first response information as an entry in a first completion queue based on a first response received from the flash memory device. The first response corresponds to a first requested memory operation from the first processor core. The operations also include updating, by the memory controller, an entry in a first CQ pointer register corresponding to the first completion queue based on storage of the first response information at the first completion queue. The operations include clearing, by the memory controller, a first entry in a CQIS register. The operations further include, after clearing the entry in the CQIS register, issuing, by the memory controller, a first MCQ ESI to the first processor core.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating a data processing system including a memory system in accordance with an embodiment of the disclosure.

FIG. 2 is a block diagram illustrating an example electronic device including the memory system according to one or more aspects of the disclosure.

FIG. 3 is a block diagram illustrating components for facilitating access to a flash memory device from a host device according to some embodiments of the disclosure.

FIG. 4 is a block diagram illustrating an example of a host device that supports reduced latency multi-circular queue (MCQ) functionality according to some embodiments of the disclosure.

FIG. 5 is a flow chart illustrating an example of a method for processing completion queue events based on MCQ event specific interrupts (ESIs) according to some embodiments of the disclosure.

FIG. 6 is flow chart illustrating an example of a method for reduced latency MCQ functionality by a host device according to some embodiments of the disclosure.

FIG. 7 is a block diagram illustrating details of an example wireless communication system according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support data processing, including techniques for storing, retrieving, and organizing data in a memory system. Aspects of this disclosure provide for operations and data structures used in those operations for supporting reduced latency multi-circular queue (MCQ) functionality at a host device that is coupled to or accesses a data system, such as a flash memory device. The flash memory device may be configured to operate according to a universal flash storage (UFS) standard and to support an MCQ event specific interrupt (ESI). To illustrate, a host controller (e.g., a host memory controller) may implement, in host controller memory using memory-mapped input/output (MMIO), multiple circular submission queues and completion queues that are capable of being accessed by multiple processor cores of the host device as part of a process to perform operations at the flash memory device. A device driver executed by one of the various processor cores may store information in a submission queue to indicate a requested memory operation, and the host controller may process the information from the submission queue to communicate with the flash memory device and perform the requested memory operation. Based on a response from the flash memory device, the host controller may store response information in a completion queue and update an entry in a completion queue pointer register, which causes issuance of a MCQ ESI to the processor core with stored the information in the submission queue. Prior to issuing the MCQ ESI, the host controller may clear a completion queue interrupt status (CQIS) register. The host controller may clear the entry in the CQIS register without performing the memory mapping that would be performed if an MCQ ESI handler executed by the processor core were to clear the entry in the CQIS register. Because the MCQ ESI indicates which completion queue causes the MCQ ESI to issue, the information cleared from the CQIS register is not needed by the MCQ ESI handler to process completion of the memory operation.

Particular implementations of the subject matter described in this disclosure may be implemented to realize one or more of the following potential advantages or benefits. In some aspects, the present disclosure provides techniques for improved performance of a memory system, such as supporting reduced latency MCQ functionality. For example, because the MCQ ESI indicates which completion queue triggered issuance of the interrupt, the CQIS register is not used to convey this information between the host controller and a processing core (e.g., a MCQ ESI handler executed by a device driver at the processing core). As such, the host controller may clear the CQIS register without clearing information that is to be used by the MCQ ESI handler. Having the host controller clear the CQIS register reduces latency of each operation at the flash memory device by eliminating at least one MMIO access by the MCQ ESI handler. As throughput in UFS-compliant devices is expected to increase such that approximately 2000 interrupts or more are issued per second, the accumulated latency reduction provided by the present disclosure may significantly improve overall throughput of communications between the host device and the flash memory device.

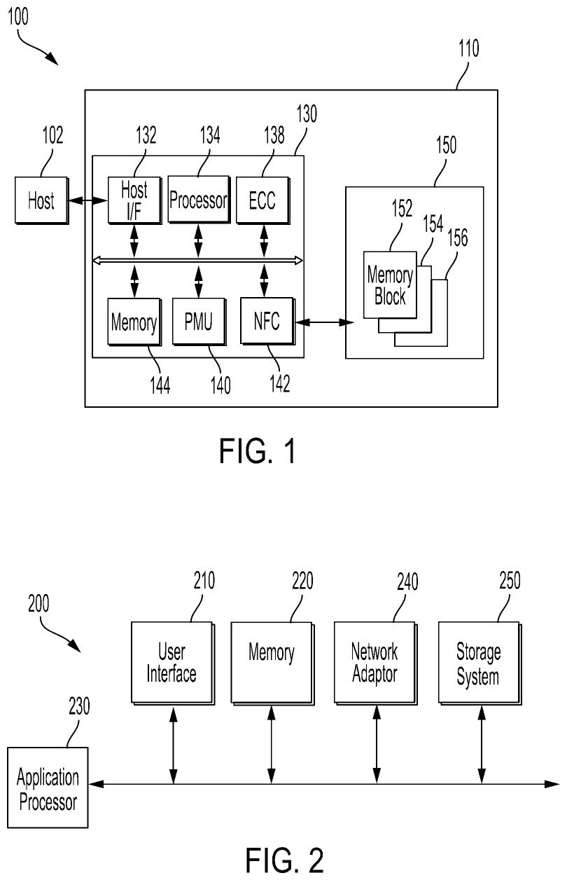

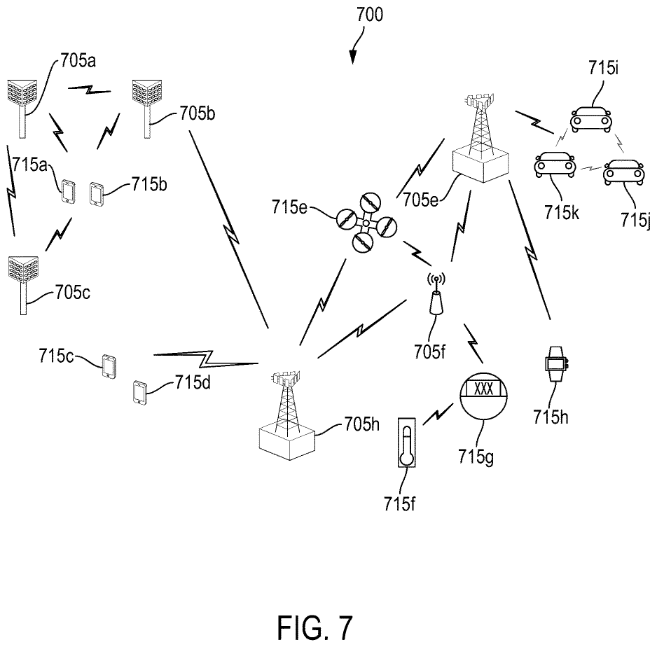

Memory may be used in a computing system organized as illustrated in FIG. 1. FIG. 1 illustrates a data processing system 100, such as may be included in a mobile computing device, according to one or more aspects of the disclosure. A memory system 110 may couple to a host device 102 through one or more channels. For example, the host device 102 and memory system 110 may be coupled through a serial interface including a single channel for the transport of data or a parallel interface including two or more channels for the transport of data. In some aspects, control data may be transferred through the same channel(s) as the data or the control data may be transferred through additional channels. The host device 102 may be, for example, a portable electronic device such as a mobile phone, an MP3 player, a laptop computer, or a non-portable electronic device such as a desktop computer, a game player, a television (TV), a media player, or a projector. As another example, the host device 102 may be an automotive computer system. Additional example host devices are illustrated and described with reference to FIG. 7.

The memory system 110 may execute operations in response to commands (e.g., a request) from the host device 102. For example, the memory system 110 may store data provided by the host device 102 and the memory system 110 may also provide stored data to the host device 102. The memory system 110 may be used as a main memory, short-term memory, or long-term memory by the host device 102. As one example of main memory, the host device 102 may use the memory system 110 to supplement or replace a system memory by using the memory system 110 to store temporary data such as data relating to operating systems and/or threads executing in the operation system. As one example of short-term memory, the host device 102 may use the memory system 110 to store a page file for an operating system. As one example of long-term memory, the host device 102 may use the memory system 110 to store user files (e.g., documents, videos, pictures) and/or application files (e.g., word processing executable, gaming application).

The memory system 110 may be implemented with any one of various storage devices, according to the protocol of a host interface for the one or more channels coupling the memory system 110 to the host device 102. The memory system 110 may be implemented with any one of various storage devices, such as a solid state drive (SSD), a multimedia card (MMC), an embedded MMC (eMMC), a reduced size MMC (RS-MMC), a micro-MMC, a secure digital (SD) card, a mini-SD, a micro-SD, a universal serial bus (USB) storage device, a universal flash storage (UFS) device, a compact flash (CF) card, a smart media (SM) card, or a memory stick.

The memory system 110 may include a memory module 150 and a controller 130 coupled to the memory module 150 through one or more channels. The memory module 150 may store and retrieve data in memory blocks 152, 154, and 156 under control of the controller 130, which may execute commands received from the host device 102. The controller 130 is configured to control data exchange between the memory module 150 and the host device 102. The storage components, such as memory blocks 152, 154, and 156 in the memory module 150 may be implemented as volatile memory device, such as, a dynamic random access memory (DRAM) and a static random access memory (SRAM), or a non-volatile memory device, such as a read only memory (ROM), a programmable ROM (PROM), an erasable programmable ROM (EPROM), an electrically erasable programmable ROM (EEPROM), a ferroelectric random access memory (FRAM), a phase-change RAM (PRAM), a magnetoresistive RAM (MRAM), a resistive RAM (SCRAM), or a NAND flash memory.

The controller 130 and the memory module 150 may be formed as integrated circuits on one or more semiconductor dies (or other substrate). In some aspects, the controller 130 and the memory module 150 may be integrated into one chip. In some aspects, the memory module 150 may include one or more chips coupled in series or parallel with each other and coupled to the controller 130, which is on a separate chip. In some aspects, the memory module 150 and controller 130 chips are integrated in a single package, such as in a package on package (PoP) system. In some aspects, the memory system 110 is integrated on a single chip with one or more or all of the components (e.g., application processor, system memory, digital signal processor, modem, graphics processor unit, memory interface, input/output interface, network adaptor) of the host device 102, such as in a system on chip (SoC). The controller 130 and the memory module 150 may be integrated into one semiconductor device to form a memory card, such as, for example, a Personal Computer Memory Card International Association (PCMCIA) card, a compact flash (CF) card, a smart media card (SMC), a memory stick, a multimedia card (MMC), an RS-MMC, a micro-MMC, a secure digital (SD) card, a mini-SD, a micro-SD, an SDHC, and a universal flash storage (UFS) device.

The controller 130 of the memory system 110 may control the memory module 150 in response to commands from the host device 102. The controller 130 may execute read commands to provide the data from the memory module 150 to the host device 102. The controller 130 may execute write commands to store data provided from the host device 102 into the memory module 150. The controller 130 may execute other commands to manage data in the memory module 150, such as program and erase commands. The controller 130 may also execute other commands to manage control of the memory system 110, such as setting configuration registers of the memory system 110. By executing commands in accordance with the configuration specified in the configuration registers, the controller 130 may control operations of the memory module 150, such as read, write, program, and erase operations.

The controller 130 may include several components configured for performing the received commands. For example, the controller 130 may include a host interface (I/F) unit 132, a processor 134, an error correction code (ECC) unit 138, a power management unit (PMU) 140, a NAND flash controller (NFC) 142, and/or a memory 144. The power management unit (PMU) 140 may provide and manage power for components within the controller 130 and/or the memory module 150.

The host IF unit 132 may process commands and data provided from the host device 102, and may communicate with the host device 102, through at least one of various interface protocols such as universal serial bus (USB), multimedia card (MMC), peripheral component interconnect express (PCI-e), serial attached SCSI (SAS), serial advanced technology attachment (SATA), parallel advanced technology attachment (PATA), small computer system interface (SCSI), enhanced small disk interface (ESDI), and integrated drive electronics (IDE). For example, the host IF unit 132 may be a parallel interface such as an MMC interface, or a serial interface such as an ultra-high speed class 1 (UHS-I)/UHS class 2 (UHS-II) or a universal flash storage (UFS) interface.

The ECC unit 138 may detect and correct errors in the data read from the memory module 150 during the read operation. The ECC unit 138 may not correct error bits when the number of the error bits is greater than a threshold number of correctable error bits, which may result in the ECC unit 138 outputting an error correction fail signal indicating failure in correcting the error bits. In some aspects, no ECC unit 138 may be provided or the ECC unit 138 may be configurable to be active for some or all of the memory module 150. The ECC unit 138 may perform an error correction operation using a coded modulation such as a low-density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), or a Block coded modulation (BCM).

The NFC 142 provides an interface between the controller 130 and the memory module 150 to allow the controller 130 to control the memory module 150 in response to a commands received from the host device 102. The NFC 142 may generate control signals for the memory module 150, such as signals for rowlines and bitlines, and process data under the control of the processor 134. Although NFC 142 is described as a NAND flash controller, other controllers may perform similar function for other memory types used as memory module 150.

The memory 144 may serve as a working memory of the memory system 110 and the controller 130. The memory 144 may store data for driving the memory system 110 and the controller 130. When the controller 130 controls an operation of the memory module 150 such as, for example, a read, write, program or erase operation, the memory 144 may store data which are used by the controller 130 and the memory module 150 for the operation. The memory 144 may be implemented with a volatile memory such as, for example, a static random access memory (SRAM) or a dynamic random access memory (DRAM). In some aspects, the memory 144 may store address mappings, a program memory, a data memory, a write buffer, a read buffer, a map buffer, and the like.

The processor 134 may control the general operations of the memory system 110, and a write operation or a read operation for the memory module 150, in response to a write request or a read request received from the host device 102, respectively. For example, the processor 134 may execute firmware, which may be referred to as a flash translation layer (FTL), to control the general operations of the memory system 110. The processor 134 may be implemented, for example, with a microprocessor or a central processing unit (CPU), or an application-specific integrated circuit (ASIC).

FIG. 2 is a block diagram illustrating an example electronic device including the data processing system 100 according to one or more aspects of the disclosure. The electronic device 200 may include a user interface 210, a memory 220, an application processor 230, a network adaptor 240, and a storage system 250 (which may be one embodiment of the data processing system 100 of FIG. 1). The application processor 230 may be coupled to the other components through a bus, such as a peripheral component interface (PCI) bus, including a PCI express (PCIe) bus.

The application processor 230 may execute computer program code, including applications, drivers, and operating systems, to coordinate performing of tasks by components included in the electronic device 200. For example, the application processor 230 may execute a storage driver for accessing the storage system 250. The application processor 230 may be part of a system-on-chip (SoC) that includes one or more other components shown in electronic device 200.

The memory 220 may operate as a main memory, a working memory, a buffer memory or a cache memory of the electronic device 200. The memory 220 may include a volatile random access memory such as a dynamic random access memory (DRAM), a synchronous dynamic random access memory (SDRAM), a double data rate (DDR) SDRAM, a DDR2 SDRAM, a DDR3 SDRAM, a low power double data rate (LPDDR) SDRAM, an LPDDR2 SDRAM, an LPDDR3 SDRAM, an LPDDR4 SDRAM, an LPDDR5 SDRAM, or an LPDDR6 SDRAM, or a nonvolatile random access memory such as a phase change random access memory (PRAM), a resistive random access memory (ReRAM), a magnetic random access memory (MRAM) and a ferroelectric random access memory (FRAM). In some aspects, the application processor 230 and the memory 220 may be combined using a package-on-package (POP).

The network adaptor 240 may communicate with external devices. For example, the network adaptor 240 may support wired communications and/or various wireless communications such as code division multiple access (CDMA), global system for mobile communication (GSM), wideband CDMA (WCDMA), CDMA-2000, time division multiple access (TDMA), long term evolution (LTE), worldwide interoperability for microwave access (WiMAX), wireless local area network (WLAN), ultra-wideband (UWB), Bluetooth, wireless display (Wi-Di), and so on, and may thereby communicate with wired and/or wireless electronic appliances, for example, a mobile electronic appliance.

The storage system 250 may store data, for example, data received from the application processor 230, and transmit data stored therein, to the application processor 230. The storage system 250 may be a non-volatile semiconductor memory device, such as a phase-change RAM (PRAM), a magnetic RAM (MRAM), a resistive RAM (ReRAM), a NAND flash memory, a NOR flash memory, or a 3-dimensional (3-D) NAND flash memory. The storage system 250 may be a removable storage medium, such as a memory card or an external drive. For example, the storage system 250 may correspond to the memory system 110 described above with reference to FIG. 1 and may be a SSD, eMMC, UFS, or other flash memory system.

The user interface 210 provide one or more graphical user interfaces (GUIs) for inputting data or commands to the application processor 230 or for outputting data to an external device. For example, the user interface 210 may include user input interfaces, such as a virtual keyboard, a touch screen, a camera, a microphone, a gyroscope sensor, or a vibration sensor, and user output interfaces, such as a liquid crystal display (LCD), an organic light emitting diode (OLED) display device, an active matrix OLED (AMOLED) display device, a light emitting diode (LED), a speaker, or a haptic motor.

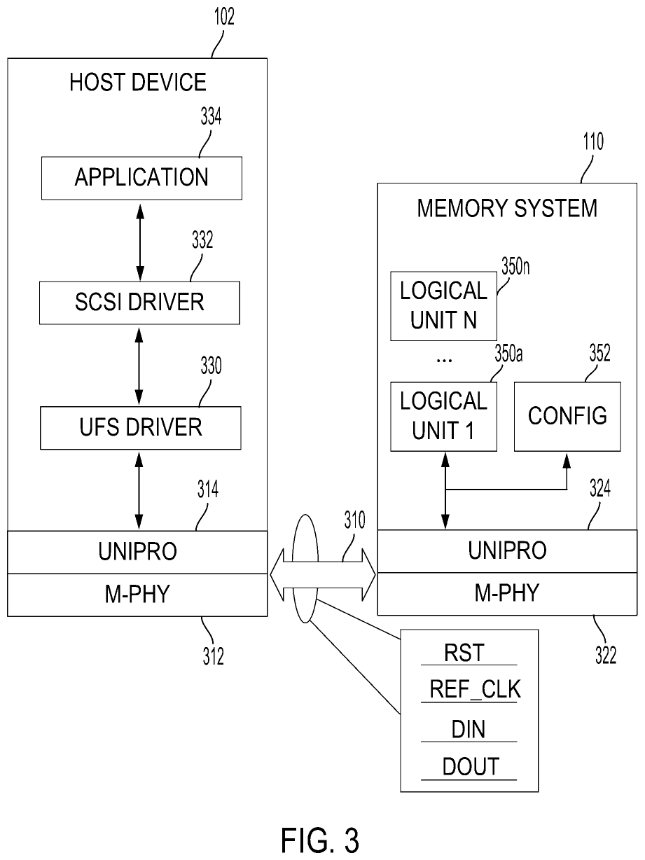

FIG. 3 is a block diagram illustrating components for facilitating access to a flash memory system from a host device according to some embodiments of the disclosure. The host device 102 accesses the memory system 110 through a memory interface 310 (e.g., a first interface). The first interface may, for example, be a memory interface such as a physical interface (PHY) connecting the host device 102 to the memory system 110. The host device 102 may include physical layer access block 312, which is configured to generate signals for output to the memory interface 310 and process signals received through the memory interface 310. The memory system 110 includes a similarly-configured physical layer access block 322 for communicating on the memory interface 310. One example physical layer specification for communicating on the memory interface 310 is the MIPI M-PHY™ physical layer specification.

The host device 102 also includes a data link layer block 314 configured to format frames of data for transmission on the memory interface 310. The frames may be provided to the physical layer access block 312 for transmission. The data link layer block 314 may receive frames from the physical layer access block 312 and decode frames of data received on the memory interface 310. The memory system 110 includes a similarly-configured data link layer block 324 for processing frames transmitted on or received on the memory interface 310 by the physical layer access block 322. One example data link protocol for communicating on a MIPI M-PHY™ physical link is the MIPI UNIPRO™ specification.

The memory system 110 includes N logical units 350a-n comprising logical memory blocks for storing information including user data (e.g., user documents, application data) and configuration data (e.g., information regarding operation of the memory system 110). The logical units 350a-n may map to portions of the physical memory blocks 152, 154, and 156. Some of the logical units 350a-n or portions of the logical units 350a-n may be configured with write protection, with boot capability, as a specific memory type (e.g., default, system code, non-persistent, enhanced), with priority access, or with replay protection as a replay protected memory block (RPMB). The physical layer access block 322 and the data link layer block 324 perform operations of a memory controller for the memory system 110 for storing and retrieving data in logical units 350a-n.

The memory system 110 also includes configuration structures 352. The configuration structures 352 may include information such as configuration descriptors for boot enable (bBootEnable), initial power mode (bInitPowerMode), RPMB active (bRPMBRegionEnable), and/or RPMB region sizes (bRPMBRegion1Size, bRPMBRegion2Size, bRPMBRegion3Size). Such configuration structures and/or parameters may, for example, be configuration structures and/or parameters identified by the UFS standard.

The host device 102 may be configured to execute one or more applications 334, such as user applications executed by an operating system under the control of a user to receive user input and provide information stored in the memory system 110 to the user. The host device 102 may include several components for interfacing the application 334 to the memory system 110 through the memory interface 310. For example, a SCSI driver 332 and a UFS driver 330 may interface the application 334 to a host memory controller that includes the data link layer block 314 and the physical layer access block 312. The SCSI driver 332 may execute at an application layer for handling transactions requested by the application 334 with the memory system 110. The UFS driver 330 may execute at a transport layer and manage operation of the data link layer block 314, such as to operate the memory interface 310 at one of a plurality of modes of operations. The modes of operations may include two or more gear settings, such as one or more PWM-GEAR settings and four or more HS-GEAR settings specifying one bitrate from 182 MBps, 364 MBps, 728 MBps, and 1457 MBps.

The memory interface 310 may include one or more lines including a reset RST line, a reference clock REF_CLK line, a data-in DIN line (for data transmissions from the host device 102 to the memory system 110), and a data-out DOUT line (for data transmissions from the memory system 110 to the host device 102). The DIN and DOUT lines may be two separate conductors, or the DIN and DOUT lines may include multiple conductors. In some embodiments, the DIN and DOUT lines may be asymmetric with the DIN line including N conductors and the DOUT line including M conductors, with N>M or M>N.

The UFS driver 330 may generate and decode packets to carry out transactions requested by the application 334. The packets are transmitted over the memory interface 310. The packets may be formatted as UFS Protocol Information Units (UPIUs). In a transaction with the memory system 110, the host device 102 is an initiator and the memory system 110 is a target. The UFS driver 330, based on the type of transaction, may form one of several types of UPIUs for handling SCSI commands, data operations, task management operations, and/or query operations. Each transaction may include one command UPIU, zero or more DATA IN or DATA OUT UPIUs, and a response UPIU. Each UPIU may include a header followed by optional fields depending on the type of UPIU.

One example transaction is a read operation. A read transaction may include the initiator (e.g., host device 102) transmitting a command UPIU for causing the target (e.g., memory system 110) to perform a read operation requested by the application 334. The target provides one or more DATA IN UPIUs in response to the command UPIU, in which the DATA IN UPIUs include the requested data. The read transaction is completed by the target transmitting a Response UPIU.

Another example transaction is a write operation. A write operation may include the initiator (e.g., host device 102) transmitting a command UPIU for causing the target (e.g., memory system 110) to perform a write operation requested by the application 334. The target provides a Ready to Transfer UPIU signaling the initiator to begin transfer of write data. The initiator then transmits one or more DATA OUT UPIUs, which are followed by a Ready to Transfer UPIU signaling the initiator to continue transfer of the write data. The sequence of DATA OUT UPIUs and Ready to Transfer UPIU continues until all write data is provided to the target, after which the target provides a Response UPIU to the initiator.

A further example transaction is a query operation. A query operation may include the initiator (e.g., host device 102) requesting information about the target (e.g., memory system 110). The initiator may transmit a Query Request UPIU to request information such as configuration, enumeration, device descriptor, flags, and/or attributes of the target. Example query operations includes read descriptor, write descriptor, read attribute, write attribute, read flag, set flag, clear flag, and/or toggle flag. Example descriptors include device, configuration, unit, interconnect, string, geometry, power, and/or device health. Example flags include fDeviceInit, fPermanenetWPEn, fPowerOnWPEn, fBackgroundOpsEn, fDeviceLifeSpanModeEn, fPurgeEnable, fRefreshEnable, fPhyResourceRemoval, fBusyRTC, and/or fPermanentlyDisableFwUpdate. Example attributes include bBootLunEn, bCurrentPowerMode, bActiveICCLevel, bOutOfORderDataEn, bBackgroundOpStatus, bPurgeStatus, bMaxDataInSize, bMaxDataOutSize, dDynCapNeeded, bRefClkFreq. Such flags may, for example, be flags identified by the UFS standard.

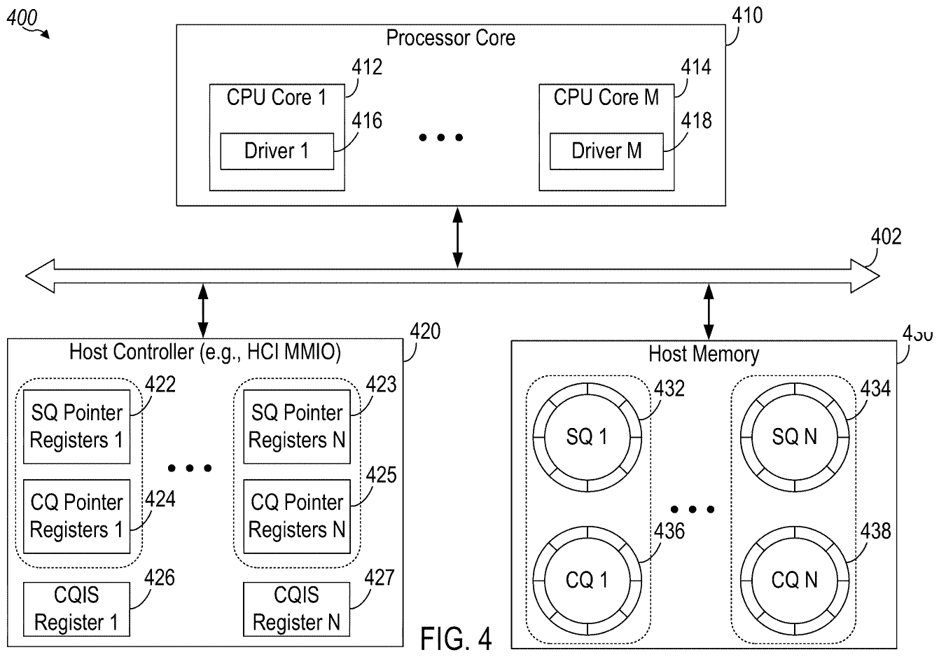

The operations and capabilities described above may be used for a memory system that supports reduced latency multi-circular queue (MCQ) functionality. Referring to FIG. 4, a block diagram of an example of a host device that supports reduced-latency MCQ functionality according to some embodiments of the disclosure is shown as host device 400. Host device 400 may be coupled to a memory system, such as the memory system 110 of FIGS. 1 and 3. The memory system may be a flash memory system configured to operate according to a UFS standard. In some implementations, host device 400 may include or correspond to host device 102 of FIG. 1, the electronic device 200 of FIG. 2, the host device 102 of FIG. 3, or a combination thereof. Additionally or alternatively, host device 400 may include or correspond to a user equipment (UE), a computing device, a desktop computing device, a laptop computing device, a tablet computing device, a mobile phone, a smart phone, a media playback device, a gaming device, an augmented reality (AR) device, a virtual reality (VR) device, an extended reality (XR) device, an internet of things (IOT) device, a smart device, a vehicular device or module, or a combination thereof.

Host device 400 may include a variety of components (such as structural, hardware components) used for carrying out one or more functions described herein. For example, these components may include processor core 410, host controller 420 (e.g., a host memory controller), and host memory 430. Processor core 410, host controller 420, and host memory 430 may be coupled together via a bus 402 (e.g., a communication bus) or other connecting hardware. In some implementations, host device 400 may include other components not shown in FIG. 4 for ease of illustration, such as one or more memory devices, one or more interfaces, and the like. Processor core 410 may include one or more central processing unit (CPU) cores that are configured to execute instructions stored in the one or more memory devices to perform operations herein, such as operations to enable applications executed by the CPU cores to communicate with host controller 420 for accessing the memory system coupled to host device 400. For example, processor core 410 may include a first CPU core 412 (“CPU Core 1”) . . . and an mth CPU core 414 (“CPU Core M”). Although two CPU cores are shown in FIG. 4, in other examples, processor core 410 may include more than two CPU cores or a single CPU core (e.g., m may be greater than two or less than two). Each CPU core may execute one or more applications, including a respective driver (e.g., a UFS driver) that enable communication between the CPU core and host controller 420 to facilitate access to the memory system coupled to host device 400. For example, first CPU core 412 may execute first driver 416 (e.g., a first instance of a UFS driver) and mth CPU core 414 may execute mth driver 418 (e.g., an mth instance of the UFS driver).

Host controller 420 may include one or more processors, microprocessors, or other hardware components that are configured to perform operations described herein for facilitating communications between host device 400 and the memory system. Host controller 420 may execute one or more instructions stored in host memory 430 to perform the operations described herein, and host controller 420 may store information and data obtained during operation in one or more registers at host controller 420, at host memory 430, or both. For example, host controller 420 may be configured to implement one or more registers using memory-mapped input/output (MMIO) at host controller 420, such as a first pair of submission queue pointer (SQ pointer) registers 422 (“SQ Pointer Registers 1”), . . . an nth pair of SQ pointer registers 423 (“SQ Pointer Registers N”), a first pair of completion queue pointer (CQ pointer) registers 424 (“CQ Pointer Registers 1”), . . . an nth pair of CQ pointer registers 425 (“CQ Pointer Registers N”), a first completion queue interrupt status (CQIS) register 426 (“CQIS Register 1”), . . . and an nth CQIS register 427 (“CQIS Register N”). Although two SQ pointer registers, two CQ pointer registers, and two CQIS registers are shown in FIG. 4, in other examples, there may be more than two or fewer than two SQ pointer registers, CQ pointer registers, and CQIS registers (e.g., n may be greater than two or less than two). SQ pointer registers 422 and 423 may be used to share information about a respective submission queue (SQ) in host memory 430 by processor core 410 and host controller 420, and CQ pointer registers 424 and 425 may be used to share information about a respective completion queue (CQ) in host memory 430 by processor core 410 and host controller 420. CQIS registers 426 and 427 may be used by host controller 420 to indicate CQ interrupt status for a corresponding completion queue, such as whether a corresponding completion queue has been updated and an interrupt is to be issued.

Host memory 430 may be configured to store instructions and data for use by host controller 420. In some implementations, host controller 420 may implement a plurality of circular queues at host memory 430 as part of supporting MCQ functionality. For example, host controller 420 may be configured to operate in accordance with a UFS standard in order to support MCQ event specific interrupts (ESIs) and other MCQ functionality, including multiple queues for enabling CPU cores 412-414 to communicate with host controller 420 to performing operations at the flash memory system. The plurality of circular queues may be accessed by multiple processor cores (e.g., first CPU core 412 and mth CPU core 414) in addition to host controller 420. The plurality of circular queues may include a first set of one or more queues configured as submission queues (SQs) and a second set of one or more queues configured as completion queues (CQs). For example, the first set of queues may include a first submission queue 432 (“SQ 1”), . . . an nth submission queue 434 (“SQ N”), a first completion queue 436 (“CQ 1”), . . . and an nth completion queue 438 (“CQ N”). Although two submission queues and two completion queues are shown in FIG. 4, in other examples, there may be more than two or fewer than two submission queues and completion queues (e.g., n may be greater than two or less than two). Each submission queue may correspond to a completion queue by a 1:1 correspondence, such that request memory operations stored in the submission queue correspond to memory operation responses stored in the completion queue. For example, first submission queue 432 may correspond to first completion queue 436, and nth submission queue 434 may correspond to nth completion queue 438. In some other implementations, a completion queue may correspond to more than one submission queues.

In some implementations, submission queues 432 and 434 and completion queues 436 and 438 are circular queues. For example, each queue may correspond to a respective plurality of entries, with a head pointer that points to the next free (e.g., unused) entry and a tail pointer that points to the last in-use entry. The head and tail pointers may advance as new entries are added to the respective queue, and when the pointers reach a last entry of the plurality of entries assigned to the respective queue, the value of the pointers “wraps around” to the first entry of the plurality of entries. For example, if a particular queue is assigned ten entries and the head pointer points to the tenth entry, after new information is stored in the tenth entry, the head pointer is updated to point to the first entry. If the head and tail pointers point to the same entry, the respective queue is empty. If the head pointer points to a different entry than the tail pointer, the respective queue contains one or more entry. Information about the head and tail pointers for submission queues 432 and 434 and completion queues 436 and 438 may be shared between host controller 420 and CPU cores 412 and 414 using SQ pointer registers 422 and 423 and CQ pointer registers 424 and 425, respectively. For example, each pair of SQ pointer registers 422 and 423 and each pair of CQ pointer registers 424 and 425 may each include a respective head pointer register and a respective tail pointer register that are designated to store head and tail pointers for the corresponding queues. Stated another way, each pair of SQ pointer registers 422 and 423 may include an SQ head pointer (SQHP) register and an SQ tail pointer (SQTP) register (e.g., a {SQHP, SQTP} register pair), and each pair of CQ pointer registers 424 and 425 may include a CQ head pointer (CQHP) register and a CQ tail pointer (CQTP) register (e.g., a {CQHP, CQTP} register pair). For example, head pointers that correspond to head entries of submission queues 432 and 434 may be stored in entries of head pointer registers of SQ pointer registers 422 and 423, respectively, and tail pointers that correspond to tail entries of submission queues 432 and 434 may be stored in entries of tail pointer registers of SQ pointer registers 422 and 423, respectively. The head pointer registers of SQ pointer registers 422 and 423 may be accessed and updated by host controller 420 to update the corresponding head pointers, and the tail pointer registers of SQ pointer registers 422 and 423 may be accessed by CPU cores 412 and 414 (e.g., drivers 416 and 418), respectively, to update the corresponding tail pointers. As another example, head pointers that correspond to head entries of completion queues 436 and 438 may be stored in entries of head pointer registers of CQ pointer registers 424 and 425, respectively, and tail pointers that correspond to tail entries of completion queues 436 and 438 may be stored in entries of tail pointer registers of CQ pointer registers 424 and 425, respectively. The tail pointer registers of CQ pointer registers 424 and 425 may be accessed and updated by host controller 420 to update the corresponding tail pointers, and the head pointer registers of CQ pointer registers 424 and 425 may be accessed by CPU cores 412 and 414 (e.g., drivers 416 and 418), respectively, to update the corresponding head pointers.

During operation, processor core 410 (e.g., CPU cores 412 and 414) may execute applications that request performance of operations at the flash memory system, and device drivers (e.g., UFS drivers) executed by the various processor cores may enable interfaces between the applications and host controller 420. For example, execution of first driver 416 by first CPU core 412 may provide an interface between an application executed at first CPU core 412 and host controller 420, and execution of mth driver 418 by mth CPU core 414 may provide an interface between an application executed at mth CPU core 414 and host controller 420. In some implementations, first driver 416 and mth driver 418 are configured to support a subset of SCSI commands for communicating with the flash memory system. CPU cores 412 and 414 may store request information at an available submission queue of submission queues 432 and 434 to request performance of corresponding operations at the flash memory device by host controller 420. Upon receiving responses from the flash memory device, host controller 420 may store response information in completion queues 436 and 438 for processing by drivers 416 and 418, respectively, to complete the requested operations.

To illustrate the communications between processor core 410 and host controller 420 during performance of memory operations at the flash memory system, first CPU core 412 may generate, due to execution of an application, write data for storage at the flash memory device. Although a write operation is described in this example, similar processing may be performed for a read operation. First driver 416 may format the write data as a UTP transfer request descriptor (UTRD), and first CPU core 412 may identify a submission queue at which the UTRD is to be stored. For example, first CPU core 412 may store the request information (e.g., the UTRD) at an entry in first submission queue 432 that is pointed to by the head pointer that corresponds to first submission queue 432. In some implementations, each CPU core of CPU cores 412 and 414 is assigned to a respective submission queue of submission queues 432 and 434. In some other implementations, submission queues may be accessed by multiple processor cores on an availability basis. In this example, first submission queue 432 may be assigned to first CPU core 412 or may be a first available submission queue identified by first CPU core 412. First CPU core 412 may store the request information as the entry in first submission queue 432 and update an entry in first SQ pointer registers 422 (e.g., the SQTP register) to indicate that a new entry has been added to first submission queue 432. Updating the entry in first SQ pointer registers 422 may cause a doorbell notification or other notification to issue to host controller 420.

Host controller 420 may detect the doorbell notification (or other notification) caused by first SQ pointer registers 422 and, because first SQ pointer registers 422 correspond to first submission queue 432, host controller 420 may access entries in first submission queue 432, in the order they were stored, based on the detected notification. Responsive to reading the entry in first submission queue 432, host controller 420 may increment the entry of the head pointer in first SQ pointer registers 422 (e.g., the SQHP register) to indicate that the entry in first submission queue 432 is free for consumption. Host controller 420 may parse the entry in first submission queue 432 and identify a requested operation to be performed at the flash memory system, in this example, a write command, and host controller 420 may facilitate performance of the requested command by the flash memory system. For example, host controller 420 may transmit (e.g., issue) a command to the flash memory system via a flash memory system interface, in this example a write command including the write data provided by first driver 416. The flash memory system may perform the write command and issue a response to host controller 420.

Host controller 420 may receive, via the flash memory system interface, the response from the flash memory system, where the response corresponds to a result of performance of the requested memory operation (e.g., the write operation). Host controller 420 may store response information (e.g., based on the response from the flash memory system) as an entry in first completion queue 436, due to first completion queue 436 corresponding to first submission queue 432. For example, host controller 420 may write one or more UFS protocol information units (UPIUs), in addition to an overall command status (OCS) field and a submission queue identifier (e.g., to indicate the corresponding submission queue), as an entry in first completion queue 436. After storing the response information as the entry in first completion queue 436, host controller 420 may update an entry in first CQ pointer registers 424 (e.g., the CQTP register) that corresponds to first completion queue 436. For example, host controller 420 may increment the tail pointer included in first CQ pointer registers 424. Updating the entry at first CQ pointer registers 424 may trigger an MCQ event-specific interrupt (MCQ ESI). Additionally, updating the entry at first CQ pointer registers 424 may cause host controller 420 to store completion queue identification information associated with first completion queue 436 at an entry in first CQIS register 426.

In legacy UFS systems, CQIS registers 426 and 427 may be used to pass the identification information for the completion queue that was updated (e.g., that triggered an interrupt) to drivers executed by the various CPU cores. However, the MCQ ESI that is triggered by the update of the entry in first completion queue 436 indicates the completion queue that triggered the interrupt. For example, each completion queue may trigger a different MCQ ESI (e.g., having a different code or interrupt identifier), and as such, information that identifies the completion queue that triggered the MCQ ESI is indicated by, or included in, the MCQ ESI itself. Because this information is conveyed by the MCQ ESI, the identification information stored in at CQIS registers 426 and 427 becomes redundant, and thus may be cleared without affecting performance of an MCQ ESI handler. Although this information is redundant when an MCQ ESI is used, host controller 420 may still write information to CQIS registers 426 and 427 in order to support legacy non-MCQ ESI operation. Alternatively, if host controller 420 is hardwired to only support MCQ ESI operation, instead of clearing CQIS registers 426 and 427, in some implementations host controller 420 may refrain from storing information at CQIS registers 426 and 427 after storing information in CQ pointer registers 424 and 425. However, such an implementation may require additional configuration of host controller 420, such as to generate MCQ ESI interrupts other than based on incrementing tail pointers in CQ pointer registers and writing information to CQIS registers, and as such, may prevent compatibility with legacy UFS-compliant configurations.

To illustrate, prior to issuing the MCQ ESI to first driver 416 (e.g., prior to host controller 420 providing the MCQ ESI signal to first CPU core 412) for triggering execution of an MCQ ESI handler, host controller 420 may clear the entry in first CQIS register 426. For example, host controller 420 may erase a value of the entry in first CQIS register 426, or set the entry to a default or predetermined value, using a single operation that does not include performing address mapping due to first CQIS register 426 being implemented in MMIO. After clearing the entry in first CQIS register 426, host controller 420 may issue the MCQ ESI, or provide the MCQ ESI signal, to first CPU core 412 (and first driver 416).

Detection of the MCQ ESI by first CPU core 412 may trigger execution of a MCQ ESI handler by first driver 416 to process an event corresponding to the entry in first completion queue 436. For example, execution of the MCQ ESI handler may cause first driver 416 to determine that first completion queue 436 is responsible for the MCQ ESI based on information included in or indicated by the MCQ ESI (such as an interrupt identification code or other information). Based on execution of the MCQ ESI handler, first driver 416 may cause first CPU core 412 to access first completion queue 436 to read the entry added by host controller and to process the response information to complete processing of the requested memory operation. Execution of the MCQ ESI handler by first driver 416 (e.g., by first CPU core 412) does not clear the entry in first CQIS register 426, as the entry is previously or at least partially concurrently cleared by host controller 420, as described above. Stated another way, execution of the MCQ ESI handler causes first driver 416 to process the event (e.g., the response to the requested memory operation) without a MMIO access to first CQIS register 426 by first driver 416. Because first driver 416 performing the clearing of first CQIS register 426 would result in performance of an address mapping operation to access first CQIS register 426, having host controller 420 clear first CQIS register 426 instead of an interrupt handler executed by first driver 416, overall latency of the memory operation is reduced.

Similar operations may be performed for memory operations requested by other CPU cores. To illustrate, mth CPU core 414 may generate, due to execution of an application, a read command for performance at the flash memory device. Although a read operation is described in this example, similar processing may be performed for a write operation, as described above. Mth driver 418 may format the read command as a UTRD, and mth CPU core 414 may identify a submission queue at which the UTRD is to be stored. For example, mth CPU core 414 may store the request information (e.g., the UTRD) at an entry in nth submission queue 434 that is pointed to by the head pointer that corresponds to nth submission queue 434. Mth CPU core 414 may store the request information as the entry in nth submission queue 434 and update an entry in nth SQ pointer registers 423 (e.g., the SQTP register) to indicate that a new entry has been added to nth submission queue 434. Updating the entry in nth SQ pointer registers 423 may cause a doorbell notification or other notification to issue to host controller 420.

Host controller 420 may detect the doorbell notification (or other notification) caused by nth SQ pointer registers 423 and, because nth SQ pointer registers 423 correspond to nth submission queue 434, host controller 420 may access the entry in nth submission queue 434 based on the detected notification. Responsive to reading the entry in nth submission queue 434, host controller 420 may update (e.g., increment) the entry of the head pointer in nth SQ pointer registers 423 (e.g., the SQHP register) to indicate that the entry in nth submission queue 434 is free for consumption. Host controller 420 may parse the entry in nth submission queue 434 and identify a requested operation to be performed at the flash memory system, in this example, a read command, and host controller 420 may facilitate performance of the requested command by the flash memory system. For example, host controller 420 may transmit (e.g., issue) a command to the flash memory system via a flash memory system interface, in this example a read command including for a memory address provided by mth driver 418. The flash memory system may perform the read command and issue a response to host controller 420 that includes read data.

Host controller 420 may receive, via the flash memory system interface, the response from the flash memory system, where the response corresponds to a result of performance of the requested memory operation (e.g., the read operation). Host controller 420 may store response information (e.g., the read data and other information) as an entry in nth completion queue 438, due to nth completion queue 438 corresponding to nth submission queue 434. For example, host controller 420 may write one or more UPIUs, in addition to an OCS field and a submission queue identifier, as an entry in nth completion queue 438. After storing the response information as the entry in nth completion queue 438, host controller 420 may update an entry in nth CQ pointer registers 425 (e.g., the CQTP register) that corresponds to nth completion queue 438. For example, host controller 420 may increment the tail pointer included in nth CQ pointer registers 425. Updating the entry at nth CQ pointer registers 425 may trigger another MCQ ESI. Additionally, updating the entry at nth CQ pointer registers 425 may cause host controller 420 to store completion queue identification information associated with nth completion queue 438 at an entry in nth CQIS register 427. As described above, host controller 420 may be configured to store information in nth CQIS register 427, even though it is then cleared, in order to support legacy UFS operations (e.g., non-MCQ ESI operations) without requiring additional changes to host controller 420 or its code. As the MCQ ESI is issued to mth driver 418 (e.g., to mth CPU core 414) for triggering execution of an MCQ ESI handler, host controller 420 may clear the entry in nth CQIS register 427. For example, clearing of the entry in nth CQIS register 427 may at least partially overlap in time with transmission of the MCQ ESI interrupt by host controller 420 or reception of the MCQ ESI interrupt by mth driver 418. As another example, issuance of the MCQ ESI interrupt by host controller 420 may cause host controller 420 to clear the entry in nth CQIS register 427 (e.g., within a few clock cycles of issuing the MCQ ESI interrupt). In some alternate implementations, host controller 420 may clear the entry in nth CQIS register 427 prior to issuing the MCQ ESI interrupt. After clearing the entry in nth CQIS register 427, host controller 420 may issue the MCQ ESI, or provide the MCQ ESI signal, to mth CPU core 414 (and mth driver 418).

Detection of the MCQ ESI by mth CPU core 414 may trigger execution of a MCQ ESI handler by mth driver 418 to process an event corresponding to the entry in nth completion queue 438. For example, execution of the MCQ ESI handler may cause mth driver 418 to determine that nth completion queue 438 is responsible for the MCQ ESI based on information included in or indicated by the MCQ ESI (such as an interrupt identification code or other information). Based on execution of the MCQ ESI handler, mth driver 418 may cause mth CPU core 414 to access nth completion queue 438 to read the entry added by host controller and to process the response information to complete processing of the requested memory operation. For example, mth driver 418 may retrieve the read data received from the flash memory system and provide the read data to the application that initiated the request for the read operation. Execution of the MCQ ESI handler by mth driver 418 (e.g., by mth CPU core 414) does not clear the entry in nth CQIS register 427, as the entry is previously or at least partially concurrently cleared by host controller 420, as described above. Stated another way, execution of the MCQ ESI handler causes mth driver 418 to process the event (e.g., the response to the requested memory operation) without a MMIO access to nth CQIS register 427 by mth driver 418. Because mth driver 418 performing the clearing of nth CQIS register 427 would result in performance of an address mapping operation to access nth CQIS register 427, having host controller 420 clear nth CQIS register 427 instead of an interrupt handler executed by mth driver 418, overall latency of the memory operation is reduced.

As explained above with reference to FIG. 4, host device 400 supports reduced latency MCQ functionality. For example, host controller 420 implements a plurality of circular submission queues (e.g., submission queues 432 and 434) and a plurality of circular completion queues (e.g., completion queues 436 and 438) that are accessible by a plurality of processor cores (e.g., first CPU core 412 and mth CPU core 414), thereby providing multi-core processor accessible MCQ functionality. The MCQ functionality is provided with reduced latency by configuring host controller 420 to clear first CQIS register 426 instead of an interrupt handler (e.g., a MCQ ESI handler) executed by first driver 416 or mth driver 418. Accordingly, latency of each memory operation performed at the flash memory system coupled to, or integrated in, host device 400 is reduced compared to other flash memory system architectures. As throughput in UFS-compliant flash memory systems is expected to increase to approximately 2000 interrupts per second, the accumulated latency reduction provided by the techniques described with reference to FIG. 4 may significantly improve overall throughput of communications between host device 400 and the flash memory system, while also providing MCQ functionality that is accessible to multiple processor cores.

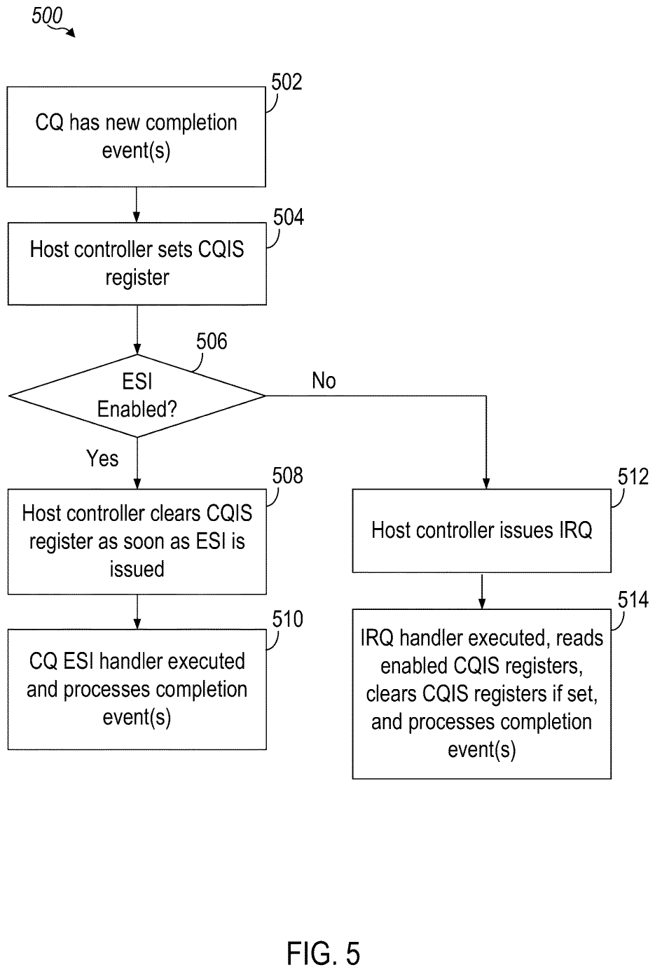

FIG. 5 is flow chart illustrating an example of a method for processing completion queue events based on MCQ ESIs according to some embodiments of the disclosure is shown as a method 500. In some implementations, method 500 may be performed by a host device, such as host device 102 of FIG. 1, electronic device 200 of FIG. 2, host device 102 of FIG. 3, host device 400 of FIG. 4. The method 500 includes, at block 502, one or more new events being added to a completion queue. For example, a host controller (e.g., a host memory controller) of the host device coupled to a flash memory device that is compliant with the UFS standard may store response information as an entry in a completion queue. The response information may be based on a response received from the flash memory device, with the response indicating result(s) of performance of a requested memory operation at the flash memory device. The host controller may also update (e.g., increment) an entry at a CQ pointer register to indicate that the new entry (e.g., the new completion event) has been added to the completion queue.

The method 500 includes, at block 504, setting, by the host controller, a value in a CQIS register. For example, the host controller may set a value in the CQIS register to indicate identification information associated with the completion queue to which the new entry was added. Updating the entry at the CQ pointer register and/or setting the entry at the CQIS register may trigger an interrupt. The method 500 includes, at block 506, optionally determining, by the host controller, whether MCQ ESI functionality is enabled. For example, if host controller is configured to support both MCQ ESI functionality and legacy UFS functionality, the host controller may determine whether it supports ESIs, such as event-specific interrupts that include or indicate a completion queue that triggered the interrupt, or whether it supports legacy interrupt requests. The legacy interrupt requests may correspond to a legacy MCQ mode that does not support ESIs or a single doorbell (SDB) mode. For example, the host controller may support MCQ ESI functionality if requested by an application executed by the host device or based on detecting a connection to a memory device that is configured to operate in accordance with an up-to-date UFS specification. The determination at block 506 may be optional, as in some implementations, the host controller is preprogrammed or otherwise mandated to support MCQ ESI functionality.

If the MCQ ESI functionality is enabled (or if the host controller is mandated to support MCQ ESI functionality), the method 500 continues to block 508, where the host controller clears the entry at the CQIS register as soon as the MCQ ESI is issued or triggered. For example, the CQIS register may be implemented in memory of the host controller using MMIO, and the host controller may clear the entry in the CQIS register without performing address mapping (or other memory mapping). The method 500 includes, at block 510, executing a completion queue ESI handler that processes the completion event(s). For example, after, or at least partially overlapping in time with, the entry at the CQIS register is cleared, the host controller may provide the MCQ ESI signal to a processor core of the host device that requested the memory operation. A device driver executed the processor core may execute an MCQ ESI handler that processes the results of the memory operation performed at the flash memory device by accessing the entry added to the completion queue by the host controller. Because the completion queue is indicated by the MCQ ESI, the MCQ ESI handler does not access the CQIS register to determine which completion queue triggered the MCQ ESI. Thus, execution of the MCQ ESI handler, and processing by the processor core, does not clear the entry at the CQIS register or perform a MMIO access (e.g., including performing address mapping) to access the CQIS register.

Alternatively, if the MCQ ESI functionality is not enabled, the method 500 progresses from block 506 to bock 512, where the host controller issues an interrupt request (IRQ) to the processor core that requested the memory operation. The method 500 includes, at block 514, executing, by the device driver at the processor core, an IRQ handler that reads enabled CQIS registers, clears the entry at the CQIS register, and processes completion of the event(s). For example, the execution of the IRQ handler may cause the processor core to access the CQIS register to read the entry that includes the completion queue identification information in order to determine which completion queue triggered the IRQ. After reading the entry in the CQIS register, the processor core executing the IRQ handler may clear the entry, which may include performance of address mapping or other memory mapping due to the CQIS being implemented in memory of the host controller using MMIO. After determining which completion queue triggered the IRQ, the processor core may read the entry from the completion queue and process the response information to complete processing of the event(s) (e.g., the requested memory operation). Thus, the method 500 described with reference to FIG. 5 enables processing of completion queue events with reduced latency if MCQ ESI functionality is supported and processing of completion queue events using legacy IRQ functionality if MCQ ESI functionality is not supported.

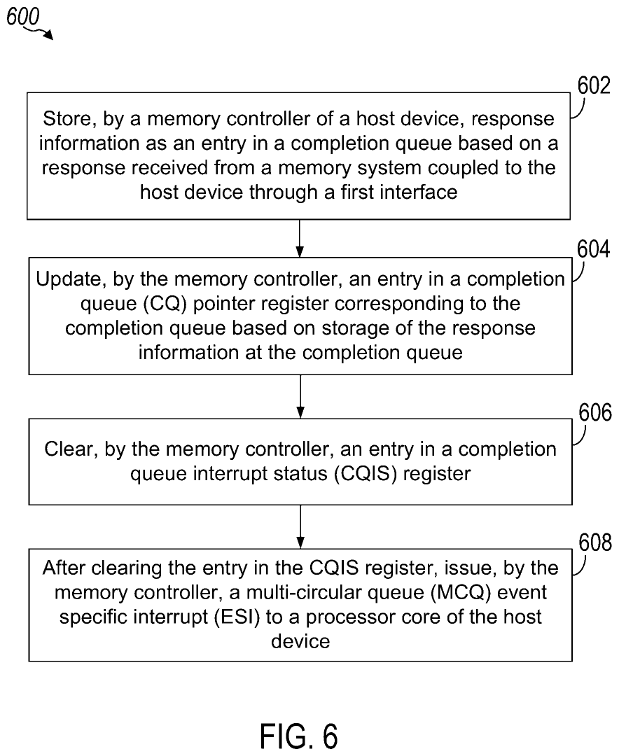

FIG. 6 is a flow chart illustrating a method for supporting reduced latency MCQ functionality by a host device according to some embodiments of the disclosure. In some implementations, the method may be performed by host device 102 of FIG. 1, electronic device 200 of FIG. 2, host device 102 of FIG. 3, or host device 400 of FIG. 4. A method 600 includes, at block 602, storing, by a memory controller (e.g., a host memory controller or host controller) of a host device, response information as an entry in a completion queue based on a response received from a memory system coupled to the host device through a first interface. For example, the memory controller may include or correspond to host controller 420 of FIG. 4, and the completion queue may include or correspond to first completion queue 436 of FIG. 4. In some implementations, the memory controller couples the host device to the memory system, and the memory system includes a flash memory device configured as a UFS device. At block 604, method 600 includes updating, by the memory controller, an entry in a CQ pointer register corresponding to the completion queue based on storage of the response information at the completion queue. For example, the CQ pointer register may include or correspond to first CQ pointer registers 424 (e.g., the CQTP register) of FIG. 4.

At block 606, method 600 includes clearing, by the memory controller, an entry in a CQIS register. For example, the CQIS register may include or correspond to first CQIS register 426 of FIG. 4. In some implementations, the entry stored at the CQIS register includes identification information associated with the completion queue. At block 608, method 600 includes, after clearing the entry in the CQIS register, issuing, by the memory controller, a MCQ ESI to a processor core of the host device. For example, the processor core may include or correspond to first CPU core 412 of FIG. 4. In some implementations, the MCQ ESI indicates the completion queue.

In some implementations, issuing the MCQ ESI to the processor core triggers execution, by a device driver executed by the processor core, of an MCQ ESI handler to process an event corresponding to the entry in the completion queue. For example, the device driver may include or correspond to first driver 416 of FIG. 4. In some such implementations, the CQIS register is implemented in MMIO at the memory controller, and the MCQ ESI handler processes the event without a MMIO access of the CQIS register by the device driver.

In some implementations, method 600 also includes detecting, by the memory controller, a notification corresponding to a SQ pointer register that corresponds to a submission queue, and accessing, by the memory controller, an entry in the submission queue based on the notification. The entry of the submission queue indicates a requested memory operation. For example, the SQ pointer register may include or correspond to first SQ pointer registers 422 (e.g., the SQTP register), and the submission queue may include or correspond to first submission queue 432 of FIG. 4. In some such implementations, method 600 further includes transmitting, by the memory controller, a command to the memory system via the first interface, and receiving, by the memory controller, the response from the memory system via the first interface. The command is based on the requested memory operation, and the response corresponds to a result of performance of the requested memory operation at the memory system.

In some implementations, the memory controller is configured to implement a plurality of completion queues and a plurality of submission queues. Each completion queue of the plurality of completion queues corresponds to a respective submission queue of the plurality of submission queues, the plurality of completion queues includes the completion queue. For example, the plurality of completion queues may include or correspond to first completion queue 436 and nth completion queue 438 of FIG. 4, and the plurality of submission queues may include or correspond to first submission queue 432 and nth submission queue 434 of FIG. 4. In some such implementations, each submission queue of the plurality of submission queues is a circular submission queue, and each completion queue of the plurality of completion queues is a circular completion Operations of method 500 or method 600 may be performed by a user equipment (UE), such as a UE described with reference to FIG. 7. For example, example operations (also referred to as “blocks”) of method 500 or method 600 may enable UE 715 (e.g., a wireless communication device) to support completion queue event processing in an MCS configuration with improved register access (e.g., improved speed due to fewer register accesses by interrupt handlers). FIG. 7 is a block diagram illustrating details of an example wireless communication system according to one or more aspects. The wireless communication system may include wireless network 700. Wireless network 700 may, for example, include a 5G wireless network. As appreciated by those skilled in the art, components appearing in FIG. 7 are likely to have related counterparts in other network arrangements including, for example, cellular-style network arrangements and non-cellular-style-network arrangements (e.g., device to device or peer to peer or ad hoc network arrangements, etc.).

Wireless network 700 illustrated in FIG. 7 includes a number of base stations 705 and other network entities. A base station may be a station that communicates with the UEs and may also be referred to as an evolved node B (eNB), a next generation eNB (gNB), an access point, and the like. Each base station 705 may provide communication coverage for a particular geographic area. In 3GPP, the term “cell” may refer to this particular geographic coverage area of a base station or a base station subsystem serving the coverage area, depending on the context in which the term is used. In implementations of wireless network 700 herein, base stations 705 may be associated with a same operator or different operators (e.g., wireless network 700 may include a plurality of operator wireless networks). Additionally, in implementations of wireless network 700 herein, base station 705 may provide wireless communications using one or more of the same frequencies (e.g., one or more frequency bands in licensed spectrum, unlicensed spectrum, or a combination thereof) as a neighboring cell. In some examples, an individual base station 705 or UE 715 may be operated by more than one network operating entity. In some other examples, each base station 705 and UE 715 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 7, base stations 705d and 705e are regular macro base stations, while base stations 705a-705c are macro base stations enabled with one of 3 dimension (3D), full dimension (FD), or massive MIMO. Base stations 705a-705c take advantage of their higher dimension MIMO capabilities to exploit 3D beamforming in both elevation and azimuth beamforming to increase coverage and capacity. Base station 705f is a small cell base station which may be a home node or portable access point. A base station may support one or multiple (e.g., two, three, four, and the like) cells.

Wireless network 700 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 715 are dispersed throughout the wireless network 700, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 715, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a flying device, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc. ; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 715a-715d of the implementation illustrated in FIG. 7 are examples of mobile smart phone-type devices accessing wireless network 700. A UE may also be a machine specifically configured for connected communication, including machine type communication (MTC), enhanced MTC (eMTC), narrowband IoT (NB-IoT) and the like. UEs 715e-715k illustrated in FIG. 7 are examples of various machines configured for communication that access wireless network 700.

A mobile apparatus, such as UEs 715, may be able to communicate with any type of the base stations, whether macro base stations, pico base stations, femto base stations, relays, and the like. In FIG. 7, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 700 may occur using wired or wireless communication links.

In operation at wireless network 700, base stations 705a-705c serve UEs 715a and 715b using 3D beamforming and coordinated spatial techniques, such as coordinated multipoint (CoMP) or multi-connectivity. Macro base station 705d performs backhaul communications with base stations 705a-705c, as well as small cell, base station 705f. Macro base station 705d also transmits multicast services which are subscribed to and received by UEs 715c and 715d. Such multicast services may include mobile television or stream video, or may include other services for providing community information, such as weather emergencies or alerts, such as Amber alerts or gray alerts.

Wireless network 700 of implementations supports mission critical communications with ultra-reliable and redundant links for mission critical devices, such UE 715e, which is a aeronautical vehicle. Redundant communication links with UE 715e include from macro base stations 705d and 705e, as well as small cell base station 705f. Other machine type devices, such as UE 715f (thermometer), UE 715g (smart meter), and UE 715h (wearable device) may communicate through wireless network 700 either directly with base stations, such as small cell base station 705f, and macro base station 705e, or in multi-hop configurations by communicating with another user device which relays its information to the network, such as UE 715f communicating temperature measurement information to the smart meter, UE 715g, which is then reported to the network through small cell base station 705f. Wireless network 700 may also provide additional network efficiency through dynamic, low-latency TDD communications or low-latency FDD communications, such as in a vehicle-to-vehicle (V2V) mesh network between UEs 715i-715k communicating with macro base station 705e.

In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably. A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards. A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long-term evolution (LTE) is a release of UMTS that uses E-UTRA. The various different network types may use different radio access technologies (RATs) and RANs.

In some implementations, devices of wireless network 700 may include or access a memory system, such as a flash memory system, described above with reference to FIGS. 1-4. As non-limiting examples, UEs 715 may include or correspond to host device 102 of FIGS. 1 and 3, and memory system 110 of FIGS. 1 and 3 may include or correspond to storage devices that are integrated in UEs 715 or that are removably coupled to UEs 715, such as a SSD, a MMC, an eMMC, a RS-MMC, a micro-MMC, a SD card, a mini-SD, a micro-SD, a USB storage device, a UFS device, a CF card, a SM card, or a memory stick. Additionally, or alternatively, base stations 705 may include or correspond to host device 102 of FIGS. 1 and 3, and memory system 110 of FIGS. 1 and 3 may include or correspond to storage devices that are integrated in base stations 705 or that are removably coupled to base stations 705, such as a SSD, a MMC, an eMMC, a RS-MMC, a micro-MMC, a SD card, a mini-SD, a micro-SD, a USB storage device, a UFS device, a CF card, a SM card, or a memory stick.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

In one or more aspects, techniques for supporting data storage, data transmission, and/or MCQ functionality with reduced latency, may include additional aspects, such as any single aspect or any combination of aspects described below or in connection with one or more other processes or devices described elsewhere herein. In a first aspect, an electronic device, such as a UE, may be an apparatus that operates as a host device that includes a memory controller configured to couple to the host device to a memory system through a first interface, in which the memory system may be integrated with the host device or externally coupled to the host device.

In a first aspect, the memory controller of the host device may be configured to perform operations including storing, by the memory controller, response information as an entry in a completion queue based on a response received from the memory system. The operations also include updating, by the memory controller, an entry in a CQ pointer register corresponding to the completion queue based on storage of the response information at the completion queue. The operations include clearing, by the memory controller, an entry in a CQIS register. The operations further include, after clearing the entry in the CQIS register, issuing, by the memory controller, a MCQ ESI to a processor core of the host device.

In a second aspect, in combination with the first aspect, the entry stored at the CQIS register includes identification information associated with the completion queue. The MCQ ESI indicates the completion queue.

In a third aspect, in combination with one or more of the first aspect or the second aspect, issuing the MCQ ESI to the processor core triggers execution, by a device driver executed by the processor core, of a MCQ ESI handler to process an event corresponding to the entry in the completion queue.

In a fourth aspect, in combination with the third aspect, execution of the MCQ ESI handler does not clear the entry in the CQIS register.

In a fifth aspect, in combination with one or more of the third aspect through the fourth aspect, the CQIS register is implemented in MMIO at the memory controller. The MCQ ESI handler processes the event without a MMIO access of the CQIS register by the device driver.

In a sixth aspect, in combination with one or more of the first aspect through the fifth aspect, the operations also include detecting, by the memory controller, a notification corresponding to a SQ pointer register that corresponds to a submission queue. The operations further include accessing, by the memory controller, an entry in the submission queue based on the notification. The entry of the submission queue indicates a requested memory operation.

In a seventh aspect, in combination with the sixth aspect, the operations also include transmitting, by the memory controller, a command to the memory system via the first interface. The command is based on the requested memory operation. The operations further include receiving, by the memory controller, the response from the memory system via the first interface. The response corresponds to a result of performance of the requested memory operation at the memory system.

In an eighth aspect, in combination with one or more of the first aspect through the seventh aspect, the memory controller is configured to implement a plurality of completion queues and a plurality of submission queues. Each completion queue of the plurality of completion queues corresponds to a respective submission queue of the plurality of submission queues. The plurality of completion queues includes the completion queue.

In a ninth aspect, in combination with the eighth aspect, each submission queue of the plurality of submission queues includes a circular submission queue, and each completion queue of the plurality of completion queues includes a circular completion queue.

In a tenth aspect, in combination with one or more of the eighth aspect through the ninth aspect, the operations also include accessing, by the memory controller, an entry in a first submission queue of the plurality of submission queues. The entry in the first submission queue indicates a first requested memory operation from a first processor core of the host device. The operations include transmitting, by the memory controller, a first command to the memory system via the first interface. The first command is based on the first requested memory operation. The operations also include accessing, by the memory controller, an entry in a second submission queue of the plurality of submission queues. The entry in the second submission queue indicates a second requested memory operation from a second processor core of the host device. The operations further include transmitting, by the memory controller, a second command to the memory system via the first interface. The second command is based on the second requested memory operation.

In an eleventh aspect, in combination with the tenth aspect, the operations also include receiving, by the memory controller, a first response from the memory system via the first interface. The first response corresponds to a result of performance of the first requested memory operation at the memory system. The operations include storing, by the memory controller, the first response as an entry in a first completion queue of the plurality of completion queues. The first completion queue corresponds to the first submission queue. The operations also include receiving, by the memory controller, a second response from the memory system via the first interface. The second response corresponds to a result of performance of the second requested memory operation at the memory system. The operations further include storing, by the memory controller, the second response as an entry in a second completion queue of the plurality of completion queues. The second completion queue corresponds to the second submission queue.

In a twelfth aspect, in combination with one or more of the first aspect through the eleventh aspect, the memory controller couples the host device to the memory system. The memory system includes a flash memory device configured as a UFS device.

In a thirteenth aspect, a method includes storing, by a memory controller of a host device, response information as an entry in a completion queue based on a response received from a memory system coupled to the host device through a first interface. The method also includes updating, by the memory controller, an entry in a CQ pointer register corresponding to the completion queue based on storage of the response information at the completion queue. The method includes clearing, by the memory controller, an entry in a CQIS register. The method further includes, after clearing the entry in the CQIS register, issuing, by the memory controller, a MCQ ESI to a processor core of the host device.

In a fourteenth aspect, in combination with the thirteenth aspect, the entry stored at the CQIS register includes identification information associated with the completion queue. The MCQ ESI indicates the completion queue.

In a fifteenth aspect, in combination with one or more of the thirteenth aspect through the fourteenth aspect, issuing the MCQ ESI to the processor core triggers execution, by a device driver executed by the processor core, of an MCQ ESI handler to process an event corresponding to the entry in the completion queue.

In a sixteenth aspect, in combination with the fifteenth aspect, the CQIS register is implemented in MMIO at the memory controller. The MCQ ESI handler processes the event without a MMIO access of the CQIS register by the device driver.

In a seventeenth aspect, in combination with one or more of the thirteenth aspect through the sixteenth aspect, the method also includes detecting, by the memory controller, a notification corresponding to a SQ pointer register that corresponds to a submission queue. The method further includes accessing, by the memory controller, an entry in the submission queue based on the notification. The entry of the submission queue indicates a requested memory operation.

In an eighteenth aspect, in combination with the seventeenth aspect, the method includes transmitting, by the memory controller, a command to the memory system via the first interface. The command is based on the requested memory operation. The method further includes receiving, by the memory controller, the response from the memory system via the first interface. The response corresponds to a result of performance of the requested memory operation at the memory system.

In a nineteenth aspect, in combination with one or more of the thirteenth aspect through the eighteenth aspect, the memory controller is configured to implement a plurality of completion queues and a plurality of submission queues. Each completion queue of the plurality of completion queues corresponds to a respective submission queue of the plurality of submission queues. The plurality of completion queues includes the completion queue.

In a twentieth aspect, in combination with one or more of the thirteenth aspect through the nineteenth aspect, the memory controller couples the host device to the memory system. The memory system includes a flash memory device configured as a UFS device.

In a twenty-first aspect, a wireless communication device includes a multi-core processor, a flash memory device, and a memory controller coupled to the multi-core processor and the flash memory device. The multi-core processor includes a first processor core and a second processor core. The memory controller is coupled to the flash memory device through a first interface and configured to perform operations including storing, by the memory controller, first response information as an entry in a first completion queue based on a first response received from the flash memory device. The first response corresponds to a first requested memory operation from the first processor core. The operations also include updating, by the memory controller, an entry in a first CQ pointer register corresponding to the first completion queue based on storage of the first response information at the first completion queue. The operations include clearing, by the memory controller, a first entry in a CQIS register. The operations further include, after clearing the entry in the CQIS register, issuing, by the memory controller, a first MCQ ESI to the first processor core.

In a twenty-second aspect, in combination with the twenty-first aspect, the first entry at the CQIS register includes identification information associated with the first completion queue. The first MCQ ESI indicates the first completion queue.

In a twenty-third aspect, in combination with one or more of the twenty-first aspect through the twenty-second aspect, the operations also include detecting, by the memory controller, a first notification corresponding to a first SQ pointer register that corresponds to a first submission queue. The operations further include accessing, by the memory controller, an entry in the first submission queue based on the first notification. The entry of the first submission queue indicates the first requested memory operation.

In a twenty-fourth aspect, in combination with the twenty-third aspect, the operations also include transmitting, by the memory controller, a first command to the flash memory device. The first command is based on the first requested memory operation. The operations further include receiving, by the memory controller, the first response from the flash memory device. The first response corresponds to a result of performance of the first requested memory operation at the flash memory device.

In a twenty-fifth aspect, in combination with one or more of the twenty-first aspect through the twenty-fourth aspect, the operations also include detecting, by the memory controller, a second notification corresponding to a second SQ pointer register that corresponds to a second submission queue. The operations further include accessing, by the memory controller, an entry in the second submission queue based on the second notification. The entry of the second submission queue indicates a second requested memory operation from the second processor core.

In a twenty-sixth aspect, in combination with the twenty-fifth aspect, the operations also include transmitting, by the memory controller, a second command to the flash memory device. The second command is based on the second requested memory operation. The operations further include receiving, by the memory controller, a second response from the flash memory device. The second response corresponds to a result of performance of the second requested memory operation at the flash memory device.

In a twenty-seventh aspect, in combination with the twenty-sixth aspect, the operations also include storing, by the memory controller, second response information as an entry in a second completion queue based on the second response. The operations include updating, by the memory controller, an entry in a second CQ pointer register corresponding to the second completion queue based on storage of the second response information at the second completion queue. The operations also include clearing, by the memory controller, a second entry in the CQIS register. The operations further include, after clearing the second entry in the CQIS register, issuing, by the memory controller, a second MCQ ESI to the second processor core.

In a twenty-eighth aspect, in combination with the twenty-seventh aspect, the second entry at the CQIS register includes identification information associated with the second completion queue. The second MCQ ESI indicates the second completion queue.

In a twenty-ninth aspect, in combination with one or more of the twenty-seventh aspect through the twenty-eighth aspect, the CQIS register is implemented in MMIO at the memory controller. Execution of a first MCQ ESI handler by the first processor core processes a first event corresponding to the entry in the first completion queue without a MMIO access of the CQIS register by the first processor core. Execution of a second MCQ ESI handler by the second processor core processes a second event corresponding to the entry in the second completion queue without a MMIO access of the CQIS register by the second processor core.

In a thirtieth aspect, in combination with one or more of the twenty-first aspect through the twenty-ninth aspect, the flash memory device is configured as a UFS device.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-7 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art that one or more blocks (or operations) described with reference to FIGS. 4, 5, or 6 may be combined with one or more blocks (or operations) described with reference to another of the figures. For example, one or more blocks (or operations) of FIG. 1 may be combined with one or more blocks (or operations) of FIG. 3. As another example, one or more blocks associated with FIG. 1 may be combined with one or more blocks (or operations) associated with FIGS. 4, 5, or 6. Additionally, or alternatively, one or more operations described above with reference to FIGS. 1-3 may be combined with one or more operations described with reference to FIGS. 4-7. Additionally, or alternatively, one or more operations of methods described herein may be performed in a different order than described. For example, operations of method 500 of FIG. 5 or method 600 of FIG. 6 may be performed out of order or in a different order than shown in FIGS. 5-6.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, opposing terms such as “upper” and “lower” or “front” and back” or “top” and “bottom” or “forward” and “backward” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel

1. An apparatus, comprising:
a memory controller of a host device configured to couple the host device to a memory system through a first interface, the memory controller configured to perform operations including:
storing, by the memory controller, response information as an entry in a completion queue based on a response received from the memory system;
updating, by the memory controller, an entry in a completion queue (CQ) pointer register corresponding to the completion queue based on storage of the response information at the completion queue;
clearing, by the memory controller, an entry in a completion queue interrupt status (CQIS) register; and
after clearing the entry in the CQIS register, issuing, by the memory controller, a multi-circular queue (MCQ) event specific interrupt (ESI) to a processor core of the host device.

2. The apparatus of claim 1, wherein the entry stored at the CQIS register comprises identification information associated with the completion queue, and wherein the MCQ ESI indicates the completion queue.

3. The apparatus of claim 1, wherein issuing the MCQ ESI to the processor core triggers execution, by a device driver executed by the processor core, of a MCQ ESI handler to process an event corresponding to the entry in the completion queue.

4. The apparatus of claim 3, wherein execution of the MCQ ESI handler does not clear the entry in the CQIS register.

5. The apparatus of claim 3, wherein the CQIS register is implemented in memory-mapped input/output (MMIO) at the memory controller, and wherein the MCQ ESI handler processes the event without a MMIO access of the CQIS register by the device driver.

6. The apparatus of claim 1, wherein the operations further comprise:
detecting, by the memory controller, a notification corresponding to a submission queue (SQ) pointer register that corresponds to a submission queue; and
accessing, by the memory controller, an entry in the submission queue based on the notification, the entry of the submission queue indicating a requested memory operation.

7. The apparatus of claim 6, wherein the operations further comprise:
transmitting, by the memory controller, a command to the memory system via the first interface, the command based on the requested memory operation; and
receiving, by the memory controller, the response from the memory system via the first interface, the response corresponding to a result of performance of the requested memory operation at the memory system.

8. The apparatus of claim 1, wherein the memory controller is configured to implement a plurality of completion queues and a plurality of submission queues, each completion queue of the plurality of completion queues corresponding to a respective submission queue of the plurality of submission queues, and wherein the plurality of completion queues includes the completion queue.

9. The apparatus of claim 8, wherein each submission queue of the plurality of submission queues comprises a circular submission queue, and wherein each completion queue of the plurality of completion queues comprises a circular completion queue.

10. The apparatus of claim 8, wherein the operations further comprise:
accessing, by the memory controller, an entry in a first submission queue of the plurality of submission queues, the entry in the first submission queue indicating a first requested memory operation from a first processor core of the host device;
transmitting, by the memory controller, a first command to the memory system via the first interface, the first command based on the first requested memory operation;
accessing, by the memory controller, an entry in a second submission queue of the plurality of submission queues, the entry in the second submission queue indicating a second requested memory operation from a second processor core of the host device; and
transmitting, by the memory controller, a second command to the memory system via the first interface, the second command based on the second requested memory operation.

11. The apparatus of claim 10, wherein the operations further comprise:
receiving, by the memory controller, a first response from the memory system via the first interface, the first response corresponding to a result of performance of the first requested memory operation at the memory system;
storing, by the memory controller, the first response as an entry in a first completion queue of the plurality of completion queues, the first completion queue corresponding to the first submission queue;
receiving, by the memory controller, a second response from the memory system via the first interface, the second response corresponding to a result of performance of the second requested memory operation at the memory system; and
storing, by the memory controller, the second response as an entry in a second completion queue of the plurality of completion queues, the second completion queue corresponding to the second submission queue.

12. The apparatus of claim 1, wherein the memory controller couples the host device to the memory system, and wherein the memory system comprises a flash memory device configured as a universal flash storage (UFS) device.

13. A method, comprising:
storing, by a memory controller of a host device, response information as an entry in a completion queue based on a response received from a memory system coupled to the host device through a first interface;
updating, by the memory controller, an entry in a completion queue (CQ) pointer register corresponding to the completion queue based on storage of the response information at the completion queue;
clearing, by the memory controller, an entry in a completion queue interrupt status (CQIS) register; and
after clearing the entry in the CQIS register, issuing, by the memory controller, a multi-circular queue (MCQ) event specific interrupt (ESI) to a processor core of the host device.

14. The method of claim 13, wherein the entry stored at the CQIS register comprises identification information associated with the completion queue, and wherein the MCQ ESI indicates the completion queue.

15. The method of claim 13, wherein issuing the MCQ ESI to the processor core triggers execution, by a device driver executed by the processor core, of an MCQ ESI handler to process an event corresponding to the entry in the completion queue.

16. The method of claim 15, wherein the CQIS register is implemented in memory-mapped input/output (MMIO) at the memory controller, and wherein the MCQ ESI handler processes the event without a MMIO access of the CQIS register by the device driver.

17. The method of claim 13, further comprising:
detecting, by the memory controller, a notification corresponding to a submission queue (SQ) pointer register that corresponds to a submission queue; and
accessing, by the memory controller, an entry in the submission queue based on the notification, the entry of the submission queue indicating a requested memory operation.

18. The method of claim 17, further comprising:
transmitting, by the memory controller, a command to the memory system via the first interface, the command based on the requested memory operation; and
receiving, by the memory controller, the response from the memory system via the first interface, the response corresponding to a result of performance of the requested memory operation at the memory system.

19. The method of claim 13, wherein the memory controller is configured to implement a plurality of completion queues and a plurality of submission queues, each completion queue of the plurality of completion queues corresponding to a respective submission queue of the plurality of submission queues, and wherein the plurality of completion queues includes the completion queue.

20. The method of claim 13, wherein the memory controller couples the host device to the memory system, and wherein the memory system comprises a flash memory device configured as a universal flash storage (UFS) device.

21-30. (canceled)
